(19) United States
(12) Patent Application Publication
(10) Pub. No.: US 2026/0341058 A1
(43) Pub. Date: Oct. 29, 2026

(54) TRAINING APPARATUS AND TRAINING METHOD

(71) Applicant: TOYOTA JIDOSHA KABUSHIKI KAISHA, Aichi-ken (JP)

(72) Inventors: Quan KONG, Toshima-ku (JP); Shizen KITAZAKI, Hachioji-shi (JP); Nicolas BOUGIE, Chiyoda-ku (JP); Norimasa KOBORI, Nakano-ku (JP)

(21) Appl. No.: 19/654,470

(22) Filed: Apr. 22, 2026

(30) Foreign Application Priority Data
Apr. 28, 2025 (JP) 2025-074935

(51) Int. Cl. G06V 20/70; G06V 10/25; G06V 10/74

(52) U.S. Cl. CPC G06V 20/70; G06V 10/25; G06V 10/761

(57) ABSTRACT

A training apparatus includes an image encoder that generates a first vector by encoding an image, a first text encoder that generates a second vector by encoding a prompt, a trainer that trains, using a label assigned to the image, the first vector, and the second vector, a model to generate a caption for the image, a misalignment information acquisition interface that acquires a modified caption in which a keyword of the caption has been modified and a keyword region corresponding to a modified keyword, a heatmap generator that generates a heatmap visualizing an attention region on which the model has focused when generating the caption, and an image reward calculator that calculates, as a first reward, the similarity between the keyword region and the attention region. The trainer trains the model such that the first reward is increased.

### CROSS-REFERENCE TO RELATED APPLICATION

This application claims priority to Japanese Patent Application No. 2025-074935, filed on Apr. 28, 2025, the entire contents of which are incorporated herein by reference.

### TECHNICAL FIELD

The present disclosure relates to a training apparatus and a training method.

### BACKGROUND

Technology for generating captions for images using generation models such as multimodal large language models (MLLMs) is known. For example, Patent Literature (PTL) 1 discloses technology in which an acquired input image is input into a first language generation model, which generates a caption for an input image capturing an inspection target, to generate a caption for the input image. Hearing content related to the inspection target is input into a second language generation model, which generates a summary of hearing content, to generate a summary of the hearing content. The generated caption is modified based on the generated summary, and the modified caption is input into an image generation model to generate a target image. PTL 1 also discloses technology in which, when an image of the inspection target is input, the acquired target image is input into a text generation model, which generates text related to an inspection target, to generate text related to the inspection target of the target image. The similarity between the text generated by the text generation model and the summary is generated, and whether the calculated similarity is within an allowable range is determined. When the similarity is not within the allowable range, the text generated by the text generation model is modified, and the modified text is output to the image generation model to repeat processing by the image generation model.

### CITATION LIST

### Patent Literature

PTL 1: JP 2021-022007 A

### SUMMARY

However, MLLMs cannot learn the relationships between misaligned parts (in which generated captions do not match actual image content) and images with only text feedback, so it is difficult to reduce hallucinations related to visual information in MLLMs.

It would be helpful to provide a training apparatus and a training method that can reduce hallucinations related to visual information in models.

A training apparatus according to an embodiment of the present disclosure includes:
an image encoder configured to generate a first vector by encoding an image;
a text encoder configured to generate a second vector by encoding a prompt;
a trainer configured to train, using a label assigned to the image, the first vector, and the second vector, a model to generate a caption for the image;
a misalignment information acquisition interface configured to acquire a modified caption in which a keyword of the caption has been modified and a keyword region corresponding to a modified keyword;
a heatmap generator configured to generate a heatmap visualizing an attention region on which the model has focused when generating the caption; and
an image reward calculator configured to calculate, as a first reward, the similarity between the keyword region and the attention region,
wherein the trainer is configured to train the model such that the first reward is increased.

A training method according to an embodiment of the present disclosure includes:
generating, by a training apparatus, a first vector by encoding an image;
generating, by the training apparatus, a second vector by encoding a prompt;
training, by the training apparatus using a label assigned to the image, the first vector, and the second vector, a model to generate a caption for the image;
acquiring, by the training apparatus, a modified caption in which a keyword of the caption has been modified and a keyword region corresponding to a modified keyword;
generating, by the training apparatus, a heatmap visualizing an attention region on which the model has focused when generating the caption; and
calculating, by the training apparatus as a first reward, the similarity between the keyword region and the attention region,
wherein the training includes training the model such that the first reward is increased.

According to the present disclosure, it becomes possible to reduce hallucinations related to visual information in models.

### BRIEF DESCRIPTION OF THE DRAWINGS

In the accompanying drawings:

FIG. 1 is a diagram illustrating an example of a configuration of a training apparatus according to a first embodiment;

FIG. 2 is a diagram illustrating an example of an image and a caption displayed on a display apparatus;

FIG. 3 is a diagram illustrating an example of modifications to the caption illustrated in FIG. 2;

FIG. 4 is a diagram illustrating an example of segmenting a modified caption;

FIG. 5 is a diagram explaining how to calculate a reward when a keyword region is specified by a marker;

FIG. 6 is a diagram explaining how to calculate a reward when a keyword region is specified by a bounding box;

FIG. 7 is a diagram illustrating an example of a configuration of a training apparatus according to a second embodiment;

FIG. 8 is a diagram illustrating an example of a configuration of a training apparatus according to a third embodiment;

FIG. 9 is a diagram illustrating an example of a configuration of a training apparatus according to a fourth embodiment; and

FIG. 10 is a flowchart illustrating an example of a procedure of a training method by the training apparatus according to the fourth embodiment.

### DETAILED DESCRIPTION

Embodiments of the present disclosure will be described in detail below, with reference to the drawings.

### First Embodiment

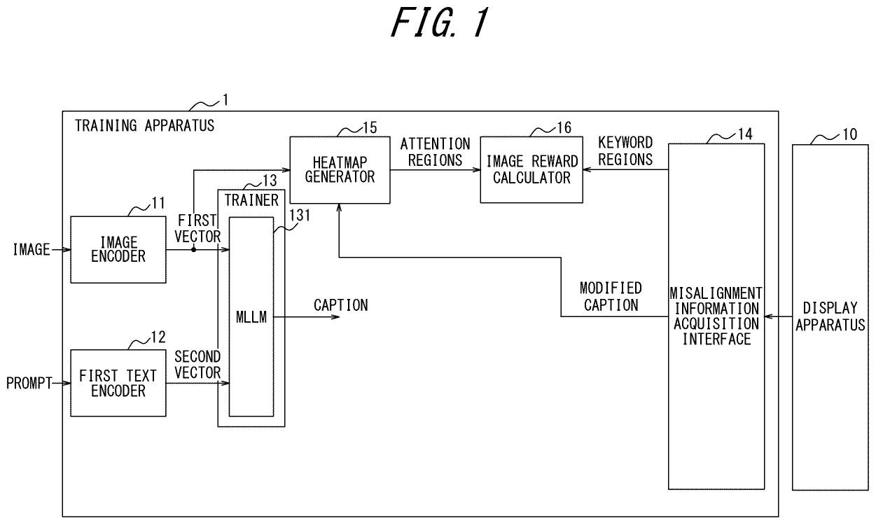

A configuration of a training apparatus according to a first embodiment will be described with reference to FIG. 1. A training apparatus 1 illustrated in FIG. 1 includes an image encoder 11, a first text encoder 12, a trainer 13, a misalignment information acquisition interface 14, a heatmap generator 15, and an image reward calculator 16.

The image encoder 11 encodes (extracts features from) an image input to the training apparatus 1 to generate a first vector. The image encoder 11 outputs the generated first vector to the trainer 13 and the heatmap generator 15.

The first text encoder 12 encodes a text prompt input to the training apparatus 1 to generate a second vector. The first text encoder 12 outputs the generated second vector to the trainer 13. The prompt is text that instructs the generation of an image caption, such as “Please describe what the image depicts.”

The trainer 13 trains a multimodal large language model (MLLM) 131. The MLLM 131 is generative AI that executes instructions based on prompts input to the training apparatus 1, on images input to the training apparatus 1. In the present embodiment, the MLLM 131 generates a descriptive sentence (caption) for the provided image. The trainer 13 trains the MLLM 131 using labels assigned to the image, the first vector, and the second vector. The trainer 13 outputs the caption generated by the MLLM 131 to a display apparatus 10.

The display apparatus 10 displays the image input to the training apparatus 1 and the caption generated by the MLLM 131.

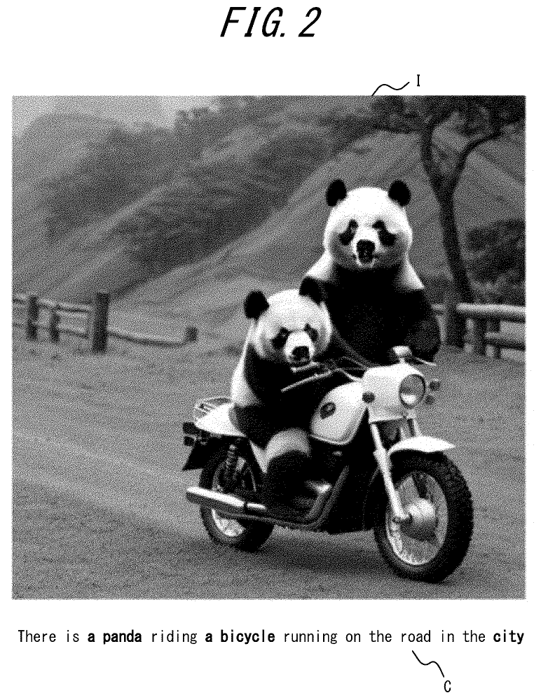

FIG. 2 is a diagram illustrating an example of an image I and a caption C displayed on the display apparatus 10. In the example illustrated in FIG. 2, there are misalignments in the caption C for the image I. The correct caption is “There are two pandas riding a motorcycle running on the road in the forest.” When the caption C is incorrect as in this example, an annotator can operate the display apparatus 10 to modify the caption C. In the present embodiment, words (keywords) in the caption C can be modified, and regions (keyword regions) in the image I corresponding to the modified keywords can be specified. In the caption C in FIG. 2, modifiable keywords are indicated in bold. The modifiable keywords may be distinguished from non-modifiable keywords in any manner, such as changing color, font, or style.

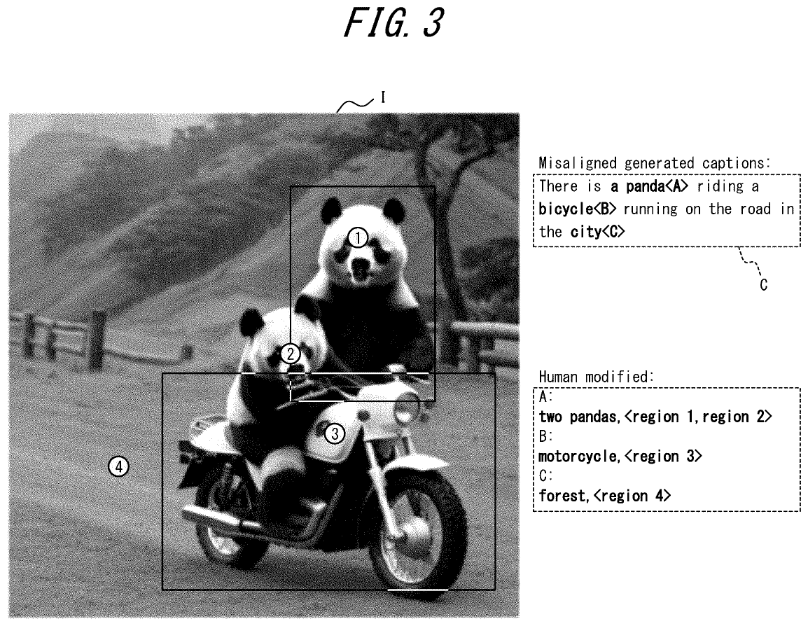

FIG. 3 is a diagram illustrating an example of modifications to the caption C illustrated in FIG. 2. In the example illustrated in FIG. 3, misaligned keywords in the caption C are “a panda”, “bicycle”, and “city”. Therefore, the annotator modifies “a panda” to “two pandas,” and specifies keyword regions 1 and 2 corresponding to “two pandas” in the image I. The annotator also modifies “bicycle” to “motorcycle,” and specifies a keyword region 3 corresponding to “motorcycle” in the image I. The annotator also modifies “city” to “forest,” and specifies a keyword region 4 corresponding to “forest” in the image I. The annotator may specify the keyword regions with markers or with bounding boxes. In the image I of FIG. 3, markers for the keyword regions 1 to 4 and bounding boxes for the keyword regions 1 and 3 are illustrated.

When the caption C is modified, the display apparatus 10 stores the modified caption C′ and the keyword regions. The display apparatus 10 outputs the keywords and the keyword regions to the misalignment information acquisition interface 14.

The misalignment information acquisition interface 14 acquires, from the display apparatus 10, the modified caption C′ with the modified keywords and the keyword regions corresponding the modified keywords. The misalignment information acquisition interface 14 outputs the acquired modified caption C′ to the heatmap generator 15. The misalignment information acquisition interface 14 also outputs the acquired keyword regions (coordinate values) to the image reward calculator 16.

The heatmap generator 15 generates a heatmap visualizing attention regions on which the MLLM131 has focused when generating the caption. The heatmap generator 15 outputs the attention regions (coordinate values) of the generated heatmap to the image reward calculator 16.

For example, the heatmap generator 15 generates a heatmap based on the cross-attention between the first vector input from the image encoder 11 and the modified caption C′ input from the misalignment information acquisition interface 14.

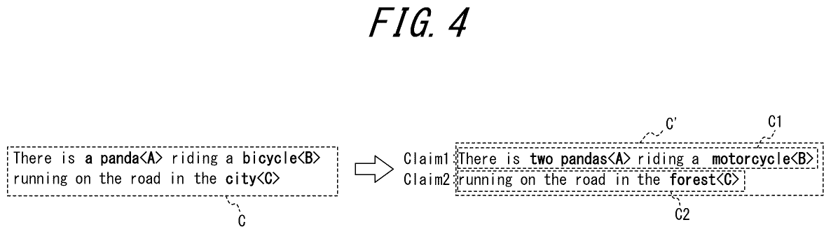

FIG. 4 is a diagram illustrating an example of segmenting the modified caption C′. The heatmap generator 15 may segment the modified caption C′ and generate a heatmap for each segmented modified caption. For example, when the caption C is modified as illustrated in FIG. 3, the heatmap generator 15 may segment the modified caption C′ into modified captions C1 and C2 as illustrated in FIG. 4. In such a case, the heatmap generator 15 generates a heatmap based on the cross-attention between the first vector and the modified caption C1, and a heatmap based on the cross-attention between the first vector and the modified caption C2.

The image reward calculator 16 calculates, as a first reward, the similarity between the keyword regions input from the misalignment information acquisition interface 14 and the attention regions input from the heatmap generator 15.

The trainer 13 trains the MLLM131 such that the first reward calculated by the image reward calculator 16 is increased. The trainer 13 updates parameters of the MLLM based on an optimization method called Direct Preference Optimization (DPO), for example. The trainer 13 may perform reinforcement learning using a separately prepared reward model.

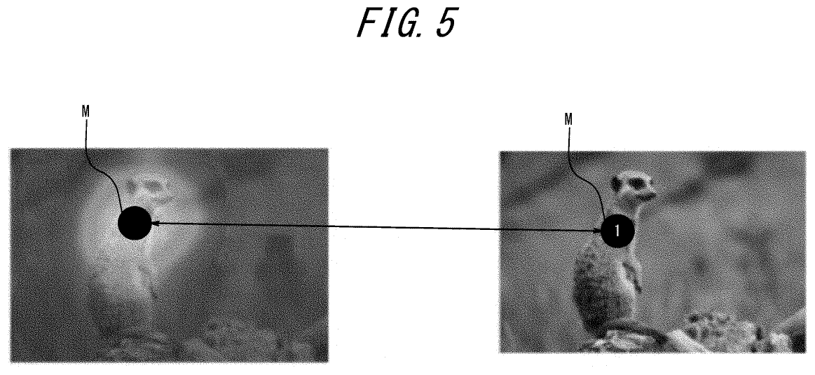

FIG. 5 is a diagram explaining how to calculate a reward when a keyword region is specified by a marker. When a keyword region is specified by a marker M as illustrated in FIG. 5, the image reward calculator 16 calculates the similarity (first reward) based on the distance between the coordinates of the center point of the marker M and the coordinates of the center point of an attention region in a heatmap. The shorter the distance between the coordinates, the larger the value of the first reward. Specifying a keyword region by a marker has the advantage of being able to accurately specify a target object because there is no mixed surrounding information. However, the definition of specifying the keyword region becomes more ambiguous than that of a bounding box.

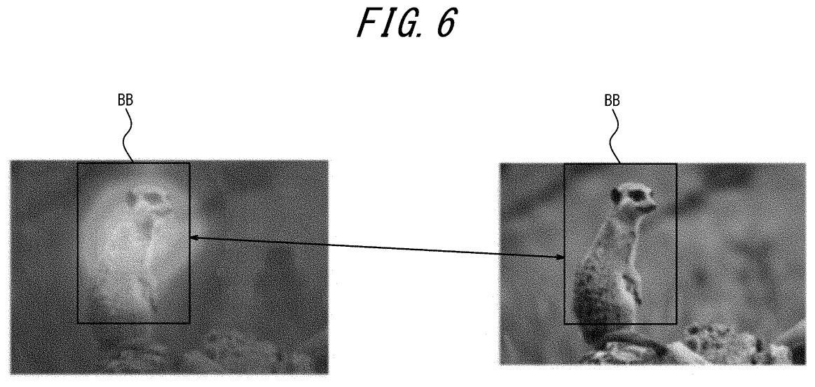

FIG. 6 is a diagram explaining how to calculate a reward when a keyword region is specified by a bounding box. When a keyword region is specified by a bounding box BB as illustrated in FIG. 6, the image reward calculator 16 calculates the similarity (first reward) based on the Intersection over Union (IoU) of the bounding box BB and a bounding box of an attention region in a heatmap. The larger the IoU (i.e., the closer the IoU to 1), the larger the value of the first reward. Specifying a keyword region by a bounding box allows for accurate recognition of the keyword region and accurate comparison with an attention region. However, in contrast to specification by a marker, there is a possibility that information unrelated to a target object may be mixed within the bounding box.

### Second Embodiment

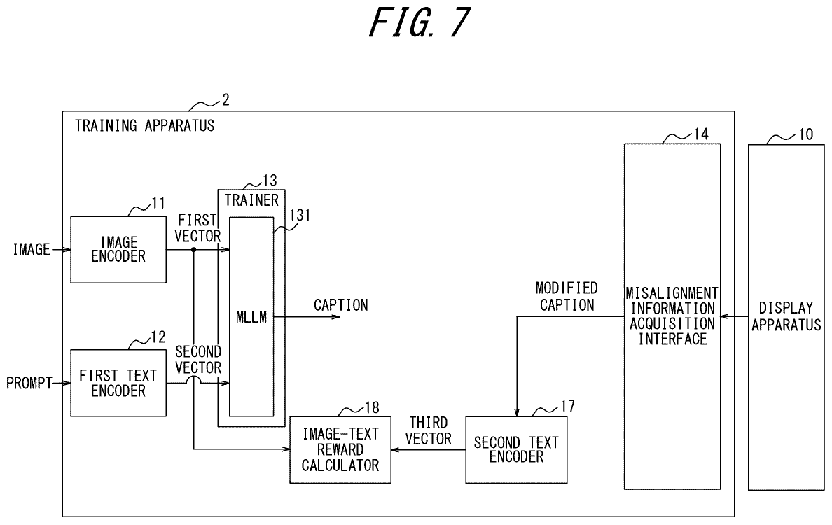

Next, a configuration of a training apparatus according to a second embodiment will be described with reference to FIG. 7. A training apparatus 2 illustrated in FIG. 7 includes an image encoder 11, a first text encoder 12, a trainer 13, a misalignment information acquisition interface 14, a second text encoder 17, and an image-text reward calculator 18. The learning apparatus 2 according to the second embodiment differs from the learning apparatus 1 according to the first embodiment in that the heatmap generator 15 and the image reward calculator 16 are omitted and the second text encoder 17 and the image-text reward calculator 18 are included. The other configurations are the same as those of the first embodiment except for the output destination of data, so the same reference numerals are assigned, and explanations are omitted as appropriate.

In the training apparatus 2, the image encoder 11 outputs a first vector to the trainer 13 and the image-text reward calculator 18. The misalignment information acquisition interface 14 does not need to acquire keyword regions, and outputs a modified caption to the second text encoder 17.

The second text encoder 17 encodes the modified caption input from the misalignment information acquisition interface 14 to generate a third vector. The second text encoder 17 outputs the generated third vector to the image-text reward calculator 18.

The image-text reward calculator 18 calculates, as a second reward, the similarity between the first vector input from the image encoder 11 and the third vector input from the second text encoder 17. For example, the image-text reward calculator 18 determines the similarity (second reward) based on the distance or Kullback-Leibler (KL) divergence between the first vector and the third vector. The shorter the distance between the vectors or the smaller the KL divergence, the larger the value of the second reward.

In the training apparatus 2, the trainer 13 trains the MLLM 131 such that the second reward calculated by the image-text reward calculator 18 is increased. The trainer 13 may update parameters of the MLLM based on an optimization method called DPO, or perform reinforcement learning using a separately prepared reward model.

### Third Embodiment

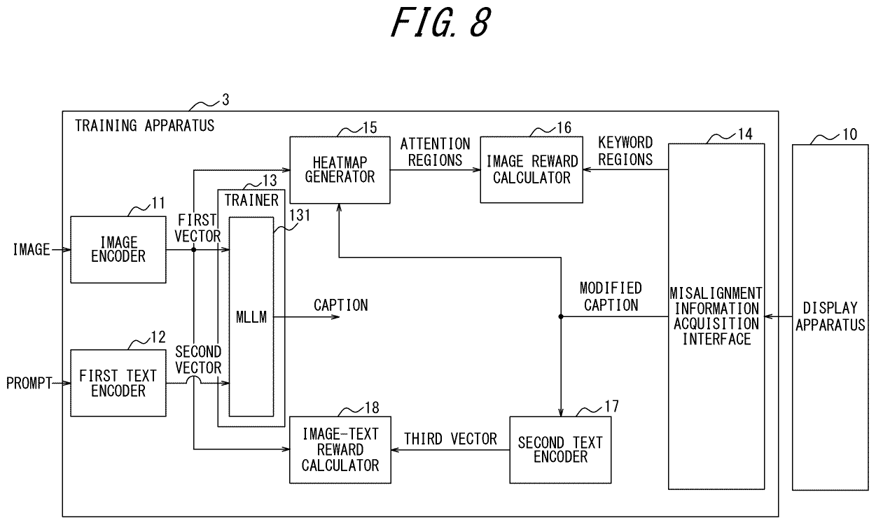

Next, a configuration of a training apparatus according to a third embodiment will be described with reference to FIG. 8. A training apparatus 3 illustrated in FIG. 8 includes an image encoder 11, a first text encoder 12, a trainer 13, a misalignment information acquisition interface 14, a heatmap generator 15, an image reward calculator 16, a second text encoder 17, and an image-text reward calculator 18. The learning apparatus 3 according to the third embodiment differs from the learning apparatus 1 according to the first embodiment in that the second text encoder 17 and the image-text reward calculator 18 are further included. The other configurations are the same as those of the first embodiment except for the output destination of data, so the same reference numerals are assigned, and explanations are omitted as appropriate.

In the training apparatus 3, the image encoder 11 outputs a first vector to the trainer 13, the heatmap generator 15, and the image-text reward calculator 18. The misalignment information acquisition interface 14 outputs an acquired modified caption C′ to the heatmap generator 15 and the second text encoder 17.

As in the second embodiment, the second text encoder 17 encodes the modified caption input from the misalignment information acquisition interface 14 to generate a third vector. The image-text reward calculator 18 calculates, as a second reward, the similarity between the first vector input from the image encoder 11 and the third vector input from the second text encoder 17.

In the training apparatus 3, the trainer 13 trains the MLLM 131 such that a first reward calculated by the image reward calculator 16 and the second reward calculated by the image-text reward calculator 18 are increased. The trainer 13 may maximize the average or weighted average of the first reward and the second reward. The trainer 13 may update parameters of the MLLM based on an optimization method called DPO, or perform reinforcement learning using a separately prepared reward model.

### Fourth Embodiment

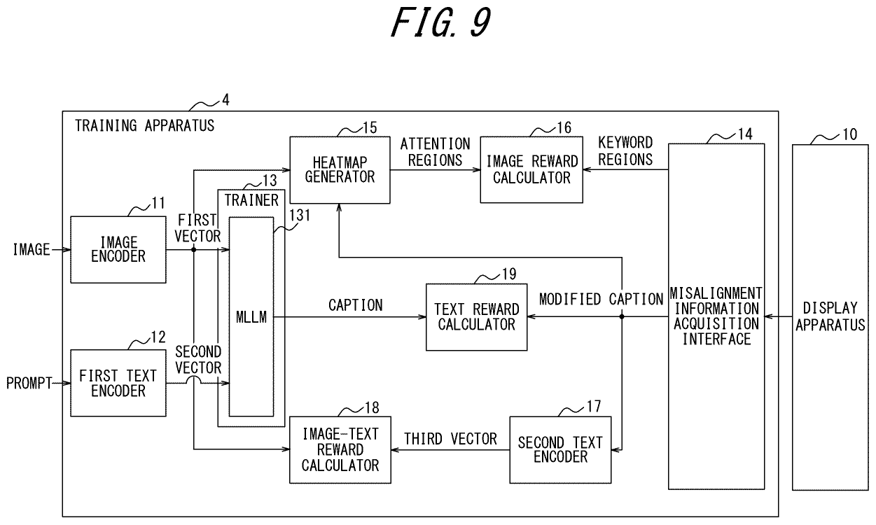

Next, a configuration of a training apparatus according to a fourth embodiment will be described with reference to FIG. 9. A training apparatus 4 illustrated in FIG. 9 includes an image encoder 11, a first text encoder 12, a trainer 13, a misalignment information acquisition interface 14, a heatmap generator 15, an image reward calculator 16, a second text encoder 17, an image-text reward calculator 18, and a text reward calculator 19. The learning apparatus 4 according to the fourth embodiment differs from the learning apparatus 3 according to the third embodiment in that the text reward calculator 19 is further included. The other configurations are the same as those of the third embodiment except for the output destination of data, so the same reference numerals are assigned, and explanations are omitted as appropriate.

In the training apparatus 3, the trainer 13 outputs a caption generated by the MLLM131 to the text reward calculator 19. The misalignment information acquisition interface 14 outputs an acquired modified caption to the heatmap generator 15, the second text encoder 17, and the text reward calculator 19.

The text reward calculator 19 calculates, as a third reward, the similarity between the caption input from the trainer 13 and the modified caption input from the misalignment information acquisition interface 14.

In the training apparatus 3, the trainer 13 trains the MLLM 131 such that a first reward, a second reward, and the third reward are increased. The trainer 13 may maximize the average or weighted average of the first reward, the second reward, and the third reward. The trainer 13 may update parameters of the MLLM based on an optimization method called DPO, or perform reinforcement learning using a separately prepared reward model.

### Training Method

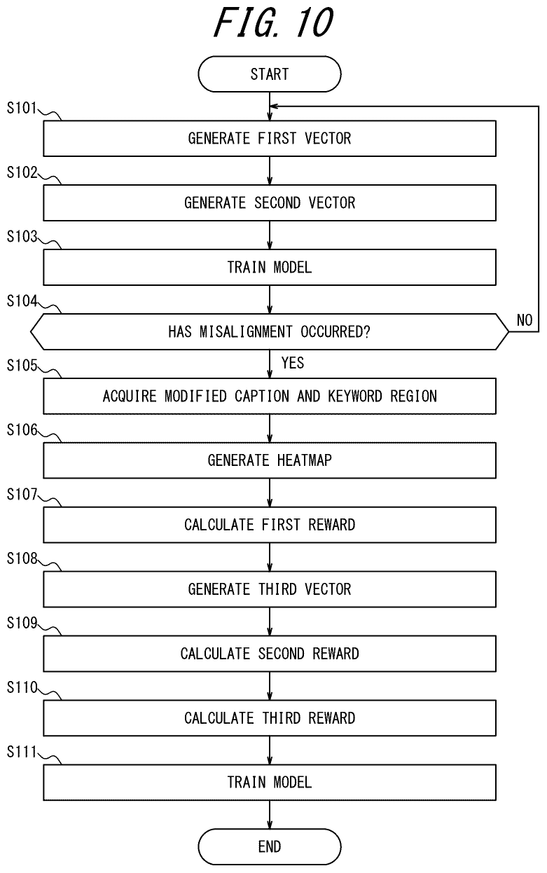

Next, a training method by the training apparatus 4 will be described. FIG. 10 is a flowchart illustrating an example of a procedure of the training method.

In step S101, the image encoder 11 of the training apparatus 4 generates a first vector by encoding an image.

In step S102, the first text encoder 12 of the training apparatus 4 generates a second vector by encoding a prompt.

In step S103, the trainer 13 of the training apparatus 4 trains the MLLM131, which generates a caption of the image, using the first vector and the second vector.

In step S104, an annotator determines whether a misalignment has occurred in the caption generated by the MLLM131. When a misalignment has occurred, the annotator modifies the caption and specifies a keyword region corresponding to a modified keyword, and the training apparatus 4 performs processing of step S105 and subsequent steps.

In step S105, the misalignment information acquisition interface 14 of the training apparatus 4 acquires the modified caption and the keyword region.

In step S106, the heatmap generator 15 of the training apparatus 4 generates a heatmap visualizing attention regions on which the MLLM131 has focused when generating the caption.

In step S107, the image reward calculator 16 of the training apparatus 4 calculates, as a first reward, the similarity of the keyword region and the attention regions.

In step S108, the second text encoder 17 of the training apparatus 4 generates a third vector by encoding the modified caption.

In step S109, the image-text reward calculator 18 of the training apparatus 4 calculates, as a second reward, the similarity between the first vector and the third vector.

In step S110, the text reward calculator 19 of the training apparatus 4 calculates, as a third reward, the similarity between the caption and the modified caption.

In step S111, the trainer 13 of the training apparatus 4 trains the MLLM131 such that the first reward, the second reward, and the third reward are increased.

The order of processing of steps S106 and S107, processing of steps S108 and S109, and processing of step S110 is arbitrary, and the training apparatus 4 may perform such processing in parallel. In a training method by the training apparatus 1, the training apparatus 1 performs only processing of steps S106 and S107, among steps S106 to S110. In a training method by the training apparatus 2, the training apparatus 2 performs only processing of steps S108 and S109, among steps S106 to S110. In a training method by the training apparatus 3, the training apparatus 3 performs only processing of steps S106 to S109, among steps S106 to S110.

### Variations

The training apparatus 1 may further include a text reward calculator 19 that calculates the above-mentioned third reward. In such a case, the trainer 13 trains the MLLM131 such that the first reward and the third reward are increased. Also, in FIG. 10, the variation of the training apparatus 1 performs only processing of steps S106, S107, and S110, among steps S106 to S110.

The training apparatus 2 may further include a text reward calculator 19 that calculates the above-mentioned third reward. In such a case, the trainer 13 trains the MLLM131 such that the second reward and the third reward are increased. Also, in FIG. 10, the variation of the training apparatus 2 performs only processing of steps S108, S109, and S110, among steps S106 to S110.

As described above, the training apparatuses 1 to 4, the variation of the training apparatus 1, and the variation of the training apparatus 2 each calculate the reward(s) using the image when a misalignment has occurred. Therefore, according to the present disclosure, it is possible to reduce hallucinations related to visual information and improve the performance of the MLLM131.

### Program

A computer capable of executing program instructions may function as each of the aforementioned training apparatuses 1 to 4, variation of the training apparatus 1, and variation of training apparatus 2. A program can cause the computer to execute the aforementioned operations, thereby causing the computer to function as each of the training apparatuses 1 to 4, the variation of the training apparatus 1, and the variation of the training apparatus 2.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as a secure digital (SD) card, a digital versatile disc (DVD), or a compact disc read only memory (CD-ROM) on which the program is stored. The program may be distributed by storing the program in a storage of a server and transferring the program from the server to another computer. The program may be provided as a program product.

The computer temporarily stores, in the memory, the program stored on the portable medium or the program transferred from the server. Then, the computer reads the program stored in the memory using a processor and executes processing in accordance with the read program using the processor. The computer may read the program directly from the portable medium, and execute processing in accordance with the program. The computer may, each time a program is transferred from the server to the computer, sequentially execute processing in accordance with the received program. Without transferring the program from the server to the computer, processing may be executed by a so-called application service provider (ASP) type service that realizes functions only by execution instructions and result acquisitions. The program encompasses information that is to be used for processing by an electronic computer and is thus equivalent to a program. For example, data that is not a direct command to a computer but has a property that regulates processing of the computer is “equivalent to a program” in this context.

The aforementioned embodiments have been explained as representative examples, but various modifications or changes can be made without departing from the spirit of the present disclosure. For example, it is possible to combine multiple configuration blocks or processing steps described in the embodiments into one, or to divide one into multiple blocks or steps.

Examples of some embodiments of the present disclosure are described below. However, it should be noted that the embodiments of the present disclosure are not limited to these examples.

[Appendix 1] A training apparatus comprising:
an image encoder configured to generate a first vector by encoding an image;
a first text encoder configured to generate a second vector by encoding a prompt;
a trainer configured to train, using a label assigned to the image, the first vector, and the second vector, a model to generate a caption for the image;
a misalignment information acquisition interface configured to acquire a modified caption in which a keyword of the caption has been modified and a keyword region corresponding to a modified keyword;
a heatmap generator configured to generate a heatmap visualizing an attention region on which the model has focused when generating the caption; and
an image reward calculator configured to calculate, as a first reward, a similarity between the keyword region and the attention region,
wherein the trainer is configured to train the model such that the first reward is increased.

[Appendix 2] The training apparatus according to appendix 1, wherein the heatmap generator is configured to generate the heatmap based on cross-attention between the first vector and the modified caption.

[Appendix 3] The training apparatus according to appendix 1 or 2, wherein the heatmap generator is configured to segment the modified caption, and generate the heatmap for each segmented modified caption.

[Appendix 4] The training apparatus according to any one of appendices 1 to 3, wherein the image reward calculator is configured to, when the keyword region is specified by a marker, calculate the similarity based on a distance between coordinates of a center point of the marker and coordinates of a center point of the attention region.

[Appendix 5] The training apparatus according to any one of appendices 1 to 4, wherein the image reward calculator is configured to, when the keyword region is specified by a bounding box, calculate the similarity based on IoU of the bounding box of the keyword region and a bounding box of the attention region.

[Appendix 6] A training apparatus comprising:
an image encoder configured to generate a first vector by encoding an image;
a first text encoder configured to generate a second vector by encoding a prompt;
a trainer configured to train, using a label assigned to the image, the first vector, and the second vector, a model to generate a caption for the image;
a misalignment information acquisition interface configured to acquire a modified caption in which a keyword of the caption has been modified and a keyword region corresponding to a modified keyword;
a second text encoder configured to generate a third vector by encoding the modified caption; and
an image-text reward calculator configured to calculate, as a second reward, a similarity between the first vector and the third vector,
wherein the trainer is configured to train the model such that the second reward is increased.

[Appendix 7] The training apparatus according to appendix 6, wherein the image-text reward calculator is configured to calculate the similarity based on a distance or KL divergence between the first vector and the third vector.

[Appendix 8] The training apparatus according to any one of appendices 1 to 5, comprising:
a second text encoder configured to generate a third vector by encoding the modified caption; and
an image-text reward calculator configured to calculate, as a second reward, a similarity between the first vector and the third vector,
wherein the trainer is configured to train the model such that the first reward and the second reward are increased.

[Appendix 9] The training apparatus according to any one of appendices 1 to 5, comprising a text reward calculator configured to calculate, as a third reward, a similarity between the caption and the modified caption,
wherein the trainer is configured to train the model such that the first reward and the third reward are increased.

[Appendix 10] The training apparatus according to appendix 6 or 7, comprising a text reward calculator configured to calculate, as a third reward, a similarity between the caption and the modified caption,
wherein the trainer is configured to train the model such that the second reward and the third reward are increased.

[Appendix 11] The training apparatus according to appendix 8, comprising a text reward calculator configured to calculate, as a third reward, a similarity between the caption and the modified caption,
wherein the trainer is configured to train the model such that the first reward, the second reward, and the third reward are increased.

[Appendix 12] A training method comprising:
generating, by a training apparatus, a first vector by encoding an image;
generating, by the training apparatus, a second vector by encoding a prompt;
training, by the training apparatus using a label assigned to the image, the first vector, and the second vector, a model to generate a caption for the image;
acquiring, by the training apparatus, a modified caption in which a keyword of the caption has been modified and a keyword region corresponding to a modified keyword;
generating, by the training apparatus, a heatmap visualizing an attention region on which the model has focused when generating the caption; and
calculating, by the training apparatus as a first reward, a similarity between the keyword region and the attention region,
wherein the training includes training the model such that the first reward is increased.

[Appendix 13] The training method according to appendix 12, comprising generating the heatmap based on cross-attention between the first vector and the modified caption.

[Appendix 14] The training method according to appendix 12 or 13, comprising segmenting the modified caption, and generating the heatmap for each segmented modified caption.

[Appendix 15] A training method comprising:
generating, by a training apparatus, a first vector by encoding an image;
generating, by the training apparatus, a second vector by encoding a prompt;
training, by the training apparatus using a label assigned to the image, the first vector, and the second vector, a model to generate a caption for the image;
acquiring, by the training apparatus, a modified caption in which a keyword of the caption has been modified and a keyword region corresponding to a modified keyword;
generating, by the training apparatus, a third vector by encoding the modified caption; and
calculating, by the training apparatus as a second reward, a similarity between the first vector and the third vector,
wherein the training includes training the model such that the second reward is increased.

[Appendix 16] The training method according to appendix 15, comprising calculating the similarity based on a distance or KL divergence between the first vector and the third vector.

[Appendix 17] The training method according to any one of appendices 12 to 14, comprising:
generating, by the training apparatus, a third vector by encoding the modified caption; and
calculating, by the training apparatus as a second reward, a similarity between the first vector and the third vector,
wherein the training includes training the model such that the first reward and the second reward are increased.

[Appendix 18] The training method according to any one of appendices 12 to 14, comprising calculating, by the training apparatus as a third reward, a similarity between the caption and the modified caption,
wherein the training includes training the model such that the first reward and the third reward are increased.

[Appendix 19] The training method according to appendix 15 or 16, comprising calculating, by the training apparatus as a third reward, a similarity between the caption and the modified caption,
wherein the training includes training the model such that the second reward and the third reward are increased. [Appendix 20] The training method according to appendix 17, comprising calculating, by the training apparatus as a third reward, a similarity between the caption and the modified caption,
wherein the training includes training the model such that the first reward, the second reward, and the third reward are increased.

1. A training apparatus comprising:
an image encoder configured to generate a first vector by encoding an image;
a first text encoder configured to generate a second vector by encoding a prompt;
a trainer configured to train, using a label assigned to the image, the first vector, and the second vector, a model to generate a caption for the image;
a misalignment information acquisition interface configured to acquire a modified caption in which a keyword of the caption has been modified and a keyword region corresponding to a modified keyword;
a heatmap generator configured to generate a heatmap visualizing an attention region on which the model has focused when generating the caption; and
an image reward calculator configured to calculate, as a first reward, a similarity between the keyword region and the attention region,
wherein the trainer is configured to train the model such that the first reward is increased.

2. The training apparatus according to claim 1, wherein the heatmap generator is configured to generate the heatmap based on cross-attention between the first vector and the modified caption.

3. The training apparatus according to claim 1, wherein the heatmap generator is configured to segment the modified caption, and generate the heatmap for each segmented modified caption.

4. The training apparatus according to claim 1, wherein the image reward calculator is configured to, when the keyword region is specified by a marker, calculate the similarity based on a distance between coordinates of a center point of the marker and coordinates of a center point of the attention region.

5. The training apparatus according to claim 1, wherein the image reward calculator is configured to, when the keyword region is specified by a bounding box, calculate the similarity based on IoU of the bounding box of the keyword region and a bounding box of the attention region.

6. The training apparatus according to claim 1, comprising, instead of the heatmap generator and the image reward calculator:
a second text encoder configured to generate a third vector by encoding the modified caption; and
an image-text reward calculator configured to calculate, as a second reward, a similarity between the first vector and the third vector,
wherein the trainer is configured to train the model such that the second reward is increased.

7. The training apparatus according to claim 6, wherein the image-text reward calculator is configured to calculate the similarity based on a distance or KL divergence between the first vector and the third vector.

8. The training apparatus according to claim 1, comprising:
a second text encoder configured to generate a third vector by encoding the modified caption; and
an image-text reward calculator configured to calculate, as a second reward, a similarity between the first vector and the third vector,
wherein the trainer is configured to train the model such that the first reward and the second reward are increased.

9. The training apparatus according to claim 1, comprising a text reward calculator configured to calculate, as a third reward, a similarity between the caption and the modified caption,
wherein the trainer is configured to train the model such that the first reward and the third reward are increased.

10. The training apparatus according to claim 6, comprising a text reward calculator configured to calculate, as a third reward, a similarity between the caption and the modified caption,
wherein the trainer is configured to train the model such that the second reward and the third reward are increased.

11. The training apparatus according to claim 8, comprising a text reward calculator configured to calculate, as a third reward, a similarity between the caption and the modified caption,
wherein the trainer is configured to train the model such that the first reward, the second reward, and the third reward are increased.

12. A training method comprising:
generating, by a training apparatus, a first vector by encoding an image;
generating, by the training apparatus, a second vector by encoding a prompt;
training, by the training apparatus using a label assigned to the image, the first vector, and the second vector, a model to generate a caption for the image;
acquiring, by the training apparatus, a modified caption in which a keyword of the caption has been modified and a keyword region corresponding to a modified keyword;
generating, by the training apparatus, a heatmap visualizing an attention region on which the model has focused when generating the caption; and
calculating, by the training apparatus as a first reward, a similarity between the keyword region and the attention region,
wherein the training includes training the model such that the first reward is increased.

13. The training method according to claim 12, comprising generating the heatmap based on cross-attention between the first vector and the modified caption.

14. The training method according to claim 12, comprising segmenting the modified caption, and generating the heatmap for each segmented modified caption.

15. A training method comprising:
generating, by a training apparatus, a first vector by encoding an image;
generating, by the training apparatus, a second vector by encoding a prompt;
training, by the training apparatus using a label assigned to the image, the first vector, and the second vector, a model to generate a caption for the image;
acquiring, by the training apparatus, a modified caption in which a keyword of the caption has been modified and a keyword region corresponding to a modified keyword;
generating, by the training apparatus, a third vector by encoding the modified caption; and
calculating, by the training apparatus as a second reward, a similarity between the first vector and the third vector,
wherein the training includes training the model such that the second reward is increased.

16. The training method according to claim 15, comprising calculating the similarity based on a distance or KL divergence between the first vector and the third vector.

17. The training method according to claim 12, comprising:
generating, by the training apparatus, a third vector by encoding the modified caption; and
calculating, by the training apparatus as a second reward, a similarity between the first vector and the third vector,
wherein the training includes training the model such that the first reward and the second reward are increased.

18. The training method according to claim 12, comprising calculating, by the training apparatus as a third reward, a similarity between the caption and the modified caption,
wherein the training includes training the model such that the first reward and the third reward are increased.

19. The training method according to claim 15, comprising calculating, by the training apparatus as a third reward, a similarity between the caption and the modified caption,
wherein the training includes training the model such that the second reward and the third reward are increased.

20. The training method according to claim 17, comprising calculating, by the training apparatus as a third reward, a similarity between the caption and the modified caption,
wherein the training includes training the model such that the first reward, the second reward, and the third reward are increased.
